(19) United States
(12) Patent Application Publication
(10) Pub. No.: US 2011/0055148 A1
(43) Pub. Date: Mar. 3, 2011

(54) SYSTEM AND METHOD FOR REDUCING ULTRASOUND INFORMATION STORAGE REQUIREMENTS

(76) Inventors: SEVALD BERG, Horten (NO); STEIN INGE RABBEN, Tamasen (NO)

(21) Appl. No.: 12/548,373

(22) Filed: Aug. 26, 2009

(51) Int. Cl. G06F 17/30

(52) U.S. Cl. 707/602; 707/E17.02

(57) ABSTRACT

A system and method for storing ultrasound information are provided. The method includes storing raw medical data of a scanned object in a reference data file, storing a set of image generating parameters into a parameter-constrained file that is separate from the reference data file, linking the set of image generating parameters stored in the parameter-constrained file to the reference data file, and generating an image by applying the set of image generating parameters to the reference data file.

### BACKGROUND OF THE INVENTION

This invention relates generally to medical diagnostic imaging systems, and more particularly, to medical imaging systems providing information storage reduction capabilities.

Ultrasound imaging systems are used in different applications to image different regions or areas (e.g., different organs) of patients. For example, an ultrasound imaging system may be utilized to generate images of organs, vasculature, heart or other portions of the body. When the operator scans an object of interest the system generates raw ultrasound data of the object of interest. The operator adjusts various parameters of the system to manipulate the raw ultrasound data to produce an ultrasound image of the object. Conventional imaging systems store the raw ultrasound data and the various parameters used to generate the image in a single ultrasound file. After acquisition, the operator may desire to re-access the single ultrasound files of raw ultrasound data and recreate the original image. When the operator accesses the single ultrasound file and enters a new set of parameters, the system creates a different second image of the object. The raw ultrasound data and the parameters used to create the second image are then stored in a separate ultrasound file. Each time the operator creates additional images to look for specific attributes in the image or to make measurements, the system saves these new parameters and the associated raw ultrasound data in a separate ultrasound file. Several ultrasound data files are often created based on one image acquisition procedure. In each case, the stored ultrasound data file includes both the raw associated ultrasound data acquired during the image acquisition procedure and the parameters used to create the desired image.

Each ultrasound data file may be in the order of 20-100 megabytes in size or larger, especially for volume/4D ultrasound. Therefore, each time the operator creates an additional image, the system stores the image in an ultrasound data file and the storage space required to store the additional ultrasound data files is increased. Because each ultrasound data file includes both the raw ultrasound data associated with the image and the parameters used to create the image, the system stores duplicate copies of the raw ultrasound data further increasing the imaging system's storage requirements as well as increasing network transfer times between the imaging system and the image archive of the digital echo lab.

### BRIEF DESCRIPTION OF THE INVENTION

In accordance with an embodiment of the invention, a method for storing ultrasound information is provided. The method includes storing raw medical data of a scanned object in a reference data file, storing a set of image generating parameters into a parameter-constrained file that is separate from the reference data file, linking the set of image generating parameters stored in the parameter-constrained file to the reference data file, and generating an image by applying the set of image generating parameters to the reference data file.

In another embodiment, a memory storage requirements reducing module is provided. The module is programmed to store raw medical data of a scanned object in a reference data file, store a set of image generating parameters into a parameter-constrained file that is separate from the reference data file, link the set of image generating parameters stored in the parameter-constrained file to the reference data file, and generate an image by applying the set of image generating parameters to the reference data file.

In a further embodiment, an ultrasound imaging system is provided. The ultrasound imaging system includes an ultrasound probe and a memory storage requirements reducing module. The module is programmed to store raw medical data of a scanned object in a reference data file, store a set of image generating parameters into a parameter-constrained file that is separate from the reference data file, link the set of image generating parameters stored in the parameter-constrained file to the reference data file, and generate an image by applying the set of image generating parameters to the reference data file.

### BRIEF DESCRIPTION OF THE DRAWINGS

FIG. 1 is a block diagram of a diagnostic ultrasound imaging system formed in accordance with various embodiments of the invention.

FIG. 2 is a block diagram of an ultrasound processor module of the diagnostic ultrasound imaging system of FIG. 1 formed in accordance with various embodiments of the invention.

FIG. 3 illustrates a flowchart of an exemplary method for storing ultrasound information in accordance with various embodiments of the invention.

FIG. 4A is a block diagram of an exemplary reference data file generated using the method shown in FIG. 3 in accordance with various embodiments of the invention.

FIG. 4B is a block diagram of an exemplary reference image and a set of subsequent images displayed on the user interface in accordance with various embodiments of the invention.

FIG. 5 is a block diagram of an exemplary reference data file and an exemplary parameter-constrained file generated using the method shown in FIG. 3 in accordance with various embodiments of the invention.

FIG. 6 is a flowchart of an exemplary method of deleting a reference data file in accordance with various embodiments of the invention.

FIG. 7 is a diagram illustrating a 3D capable miniaturized ultrasound system formed in accordance with an embodiment of the invention.

FIG. 8 is a diagram illustrating a 3D capable hand carried or pocket-sized ultrasound imaging system formed in accordance with an embodiment of the invention.

FIG. 9 is a diagram illustrating a 3D capable console type ultrasound imaging system formed in accordance with an embodiment of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. One or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

A detailed description of an exemplary ultrasound imaging system will first be provided followed by a detailed description of various embodiments of methods and systems for reducing ultrasound information storage requirements.

At least one technical effect of the various embodiments of the systems and methods described herein is to reduce the demands on the ultrasound system storage devices and network data transfer capacity. The method and system specifically utilize restored data that only contains the information used to generate the image not the raw ultrasound data. The raw ultrasound data is then stored only once in the reference data file. The subsequent stored files include pointers or indices to link the information stored in each subsequent file with the raw ultrasound data stored in the reference data file. The subsequent data files are therefore referred to as parameter-constrained files because the subsequent data files are non-data files. The parameter-constrained files do not include the raw ultrasound data but do include the information or parameters used to generate the specific subsequent image and the pointer or indicia indicating the location of the raw ultrasound data. The method is completely transparent to the user and also performed within a Dicom database environment.

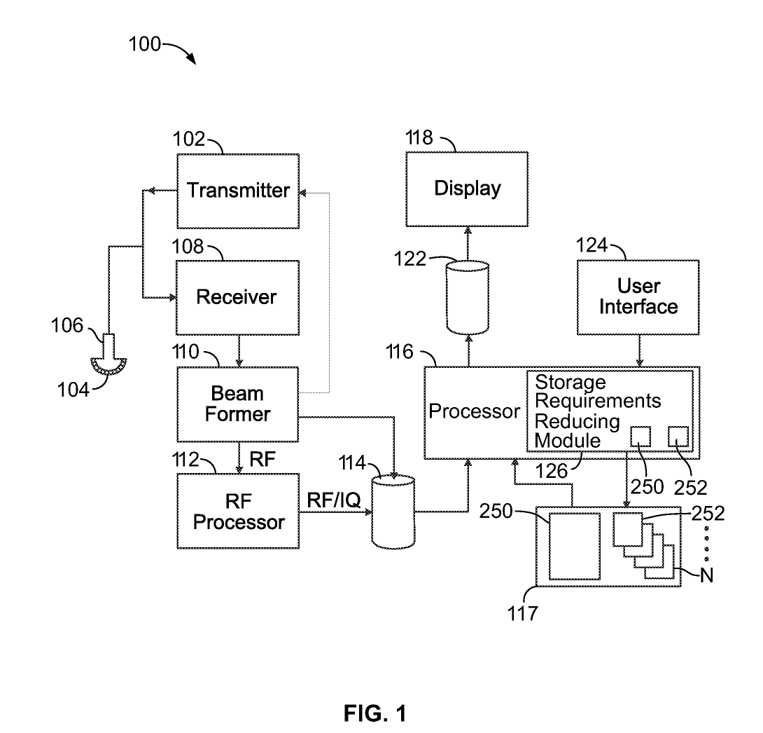

FIG. 1 is a block diagram of an ultrasound system 100 constructed in accordance with various embodiments of the invention. The ultrasound system 100 is capable of steering (mechanically and/or electronically) a soundbeam in 3D space, and is configurable to acquire information corresponding to a plurality of two-dimensional (2D) or three-dimensional (3D) representations or images of a region of interest (ROI) in a subject or patient. One such ROI may be a human heart or the myocardium (muscles) of a human heart. The ultrasound system 100 is also configurable to acquire 2D and 3D images in one or more planes of orientation. In operation, real-time ultrasound imaging using a matrix or 3D ultrasound probe may be provided.

The ultrasound system 100 includes a transmitter 102 that, under the guidance of a beamformer 110, drives an array of elements 104 (e.g., piezoelectric elements) within a probe 106 to emit pulsed ultrasonic signals into a body. A variety of geometries may be used. The ultrasonic signals are back-scattered from structures in the body, like blood cells or muscular tissue, to produce echoes that return to the elements 104. The echoes are received by a receiver 108. The received echoes are passed through the beamformer 110, which performs receive beamforming and outputs an RF signal. In one embodiment, the RF signal passes through an RF processor 112. The RF processor 112 may include a complex demodulator (not shown) that demodulates the RF signal to form IQ data pairs representative of the echo signals. The RF or IQ signal data may then be routed directly to an image buffer or memory device 114 for storage. Optionally, the RF signal output from the beamformer 110 may be directly routed to the memory device.

In the above-described embodiment, the beamformer 110 operates as a transmit and receive beamformer. In an alternative embodiment, the probe 106 includes a 2D array with sub-aperture receive beamforming inside the probe. The beamformer 110 may delay, apodize and sum each electrical signal with other electrical signals received from the probe 106. The summed signals represent echoes from the ultrasound beams or lines. The summed signals are output from the beamformer 110 to an RF processor 112. The RF processor 112 may generate different data types, such as B-mode, color Doppler (velocity/power/variance), tissue Doppler (velocity), and Doppler energy, for one or more scan planes or different scanning patterns. For example, the RF processor 112 may generate tissue Doppler data for multiple (e.g., three) scan planes. The RF processor 112 gathers the information (e.g. I/Q, B-mode, color Doppler, tissue Doppler, and Doppler energy information) related to multiple data slices and stores the data information with time stamp and orientation/rotation information in the memory 114. The information output from the RF Processor 112 and/or the memory 114 is referred to herein as the raw ultrasound data.

The ultrasound system 100 also includes a processor 116 to process the acquired ultrasound information (e.g., the raw ultrasound data) and prepare frames of ultrasound information for display on a display 118. The processor 116 is adapted to perform one or more processing operations according to a plurality of selectable ultrasound modalities on the acquired ultrasound data. Acquired ultrasound data may be processed and displayed in real-time during a scanning session as the echo signals are received. Additionally or alternatively, the ultrasound data may be stored temporarily in memory 114 during a scanning session and then processed and displayed in an off-line operation.

The processor 116 is connected to a user interface 124 that may control operation of the processor 116 and receive user inputs as explained below in more detail. The user interface 124 may include hardware components (e.g., keyboard, mouse, trackball, etc.), software components (e.g., a user display) or a combination thereof. The processor 116 also includes a memory storage requirements reducing module 126 that performs file size reduction operations. File size reduction operations include generating a reference data file 250 that includes both the raw ultrasound data and a set of parameters used to generate a reference image. The module 126 utilizes the raw ultrasound data and subsequent sets of parameters to generate subsequent images that are each stored in a respective file 252. Each subsequent file includes a pointer that links the subsequent files 252 to the reference data file 250. The reference data file 250 does not include or excludes a pointer. Each subsequent file 252 does not include or excludes the raw ultrasound data. Utilizing the raw ultrasound data that is only stored in the reference data file enables multiple subsequent images. The subsequent files 252 exclude the raw ultrasound data to reduce the demands on the ultrasound system storage devices and the network data transfer capacity. The reference data file 250 and the subsequent files 252 may be stored in a local memory in the processor device 116 or may be stored in a separate memory device 117 and accessed directly by the processor device 116 as shown in FIG. 1.

The display 118 includes one or more monitors that present patient information, including diagnostic ultrasound images to the user for diagnosis and analysis (e.g., images generated using image files having a reduced file size). One or both of memory 114 and memory 122 may store 3D data sets of the ultrasound data, where such 3D data sets are accessed to present 2D (and/or 3D images) as described herein. The images may be modified and the display settings of the display 118 also manually adjusted using the user interface 124.

It should be noted that although the various embodiments may be described in connection with an ultrasound system, the methods and systems described herein are not limited to ultrasound imaging or a particular configuration thereof. In particular, the various embodiments may be implemented in connection with different types of imaging, including, for example, magnetic resonance imaging (MRI) and computed-tomography (CT) imaging or combined imaging systems. Further, the various embodiments may be implemented in other non-medical imaging systems, for example, non-destructive testing systems.

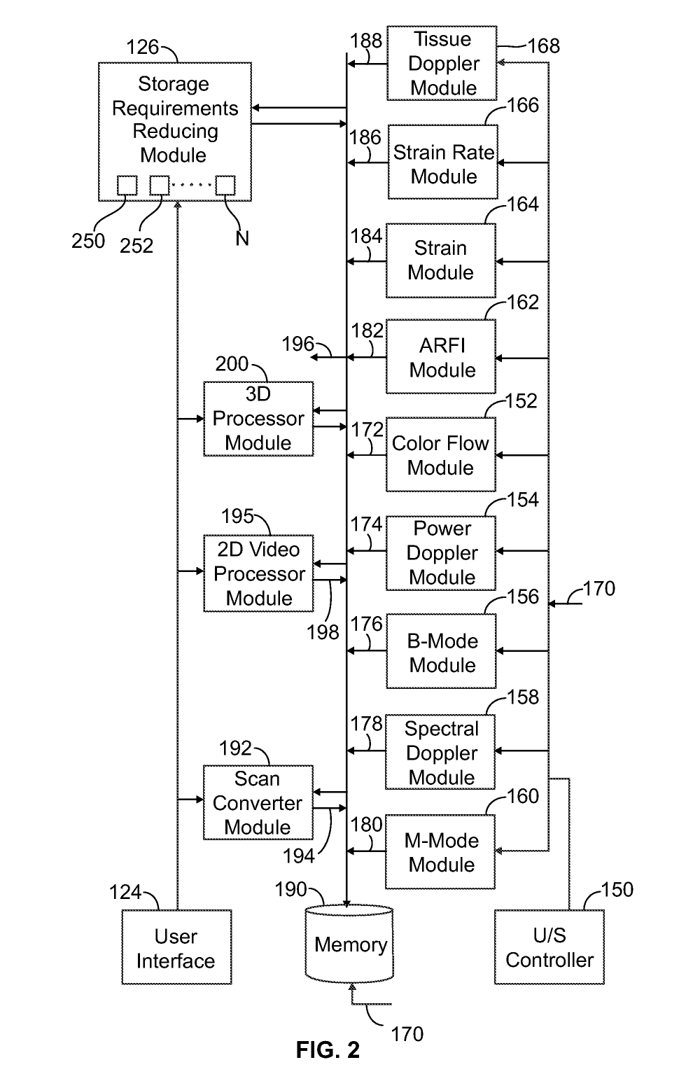

FIG. 2 illustrates an exemplary block diagram of an ultrasound processor module 136, which may be embodied as the processor 116 of FIG. 1 or a portion thereof. The ultrasound processor module 136 is illustrated conceptually as a collection of sub-modules, but may be implemented utilizing any combination of dedicated hardware boards, DSPs, processors, etc. Alternatively, the sub-modules of FIG. 2 may be implemented utilizing an off-the-shelf PC with a single processor or multiple processors, with the functional operations distributed between the processors. As a further option, the sub-modules of FIG. 2 may be implemented utilizing a hybrid configuration in which certain modular functions are performed utilizing dedicated hardware, while the remaining modular functions are performed utilizing an off-the shelf PC and the like. The sub-modules also may be implemented as software modules within a processing unit.

The operations of the sub-modules illustrated in FIG. 2 may be controlled by a local ultrasound controller 150 or by the processor module 136. The sub-modules 152-168 perform mid-processor operations. The ultrasound processor module 136 may receive ultrasound data 170 in one of several forms. In the embodiment of FIG. 2, the received ultrasound data 170 constitutes I,Q data pairs representing the real and imaginary components associated with each data sample. The I,Q data pairs are provided to one or more of a color-flow sub-module 152, a power Doppler sub-module 154, a B-mode sub-module 156, a spectral Doppler sub-module 158 and an M-mode sub-module 160. Optionally, other sub-modules may be included such as an Acoustic Radiation Force Impulse (ARFI) sub-module 162, a strain module 164, a strain rate sub-module 166, a Tissue Doppler (TDE) sub-module 168, among others. The strain sub-module 162, strain rate sub-module 166 and TDE sub-module 168 together may define an echocardiographic processing portion.

Each of sub-modules 152-168 are configured to process the I,Q data pairs in a corresponding manner to generate color-flow data 172, power Doppler data 174, B-mode data 176, spectral Doppler data 178, M-mode data 180, ARFI data 182, echocardiographic strain data 182, echocardiographic strain rate data 186 and tissue Doppler data 188, all of which may be stored in a memory device 190 (or memory 114 or memory 122 shown in FIG. 1) temporarily before subsequent processing. The data 172-188 may be stored, for example, as sets of vector data values, where each set defines an individual ultrasound image frame. The vector data values are generally organized based on the polar coordinate system.

A scan converter sub-module 192 access and obtains from the memory 190 the vector data values associated with an image frame and converts the set of vector data values to Cartesian coordinates to generate an ultrasound image frame 194 formatted for display. The ultrasound image frames 194 generated by the scan converter module 192 may be provided back to the memory 190 for subsequent processing or may be provided to the memory 114 or the memory 122. Once the scan converter sub-module 192 generates the ultrasound image frames 194 associated with, for example, the strain data, strain rate data, and the like, the image frames may be restored in the memory 190 or communicated over a bus 196 to a database (not shown), the memory 114, the memory 122 and/or to other processors, for example, the memory storage requirements reducing module 126.

The module 126 may be implemented as a hardware device or implements as a set of instructions that are stored in the memory 190. The module 126 is configured to store various ultrasound data files. The ultrasound data files include the reference data file 250 and at least one subsequent data file 252. The reference data file 250 includes raw ultrasound data and a set of image generating parameters. Each subsequent data file includes a set of image generating parameters that are used to generate a requested image. In the exemplary embodiment, the set of image generating parameters stored in each subsequent data file is different than the set of imaging generating parameters stored in the reference data file. The subsequent files are parameter constrained files that do not include the raw ultrasound data, but do include the specific parameters utilized by the module 126 to generate the respective subsequent image.

Each subsequent data file is linked to the reference data file using a reference file pointer or indicia. The pointer or indicia enables the module 126 to access or retrieve the raw ultrasound data file stored in the reference data file 250. The module then creates or recreates an image using the image generating parameters stored in the subsequent file 252. Each subsequent data file 252 may include a different set of image generating parameters to create or recreate an ultrasound image associated with the respective set of imaging parameters stored in the respective subsequent data file 252.

Referring again to FIG. 2, it may be desired to view functional ultrasound images or associated data (e.g., strain curves or traces) relating to echocardiographic functions in real-time on the display 118 (shown in FIG. 1). To do so, the scan converter sub-module 192 obtains strain or strain rate vector data sets for images stored in the memory 190. The vector data is interpolated where necessary and converted into an X,Y format for video display to produce ultrasound image frames. The scan converted ultrasound image frames are provided to a display controller (not shown) that may include a video processor that maps the video to a grayscale mapping for video display (e.g., 2D gray-scale projection). The grayscale map may represent a transfer function of the raw ultrasound data to displayed gray levels. Once the video data is mapped to the grayscale values, the display controller controls the display 118 (shown in FIG. 1), which may include one or more monitors or windows of the display, to display the image frame. The echocardiographic image displayed in the display 118 is produced from image frames of data in which each datum indicates the intensity or brightness of a respective pixel in the display. In this example, the displayed image represents muscle motion in a region of interest being imaged based on 2D tracking applied to, for example, a multi-plane image acquisition.

Referring again to FIG. 2, a 2D video processor sub-module 195 combines one or more of the frames generated from the different types of ultrasound information. For example, the 2D video processor sub-module 195 may combine a different image frames by mapping one type of data to a grayscale map and mapping the other type of data to a color map for video display. In the final displayed image, color pixel data may be superimposed on the grayscale pixel data to form a single multi-mode image frame 198 (e.g., functional image) that is again re-stored in the memory 190 or communicated over the bus 196. Successive frames of images may be stored as a cine loop in the memory 190 or memory 122 (shown in FIG. 1). The cine loop represents a first in, first out circular image buffer to capture image data that is displayed in real-time to the user. The user may freeze the cine loop by entering a freeze command at the user interface 124. The user interface 124 may include, for example, a keyboard and mouse and all other input controls associated with inputting information into the ultrasound system 100 (shown in FIG. 1).

A 3D processor sub-module 200 is also controlled by the user interface 124 and accesses the memory 190 to obtain raw 3D ultrasound data that is then used to generate three dimensional images, such as through volume rendering or surface rendering algorithms as are known. The three dimensional images may be generated utilizing various imaging techniques, such as ray-casting, maximum intensity pixel projection and the like.

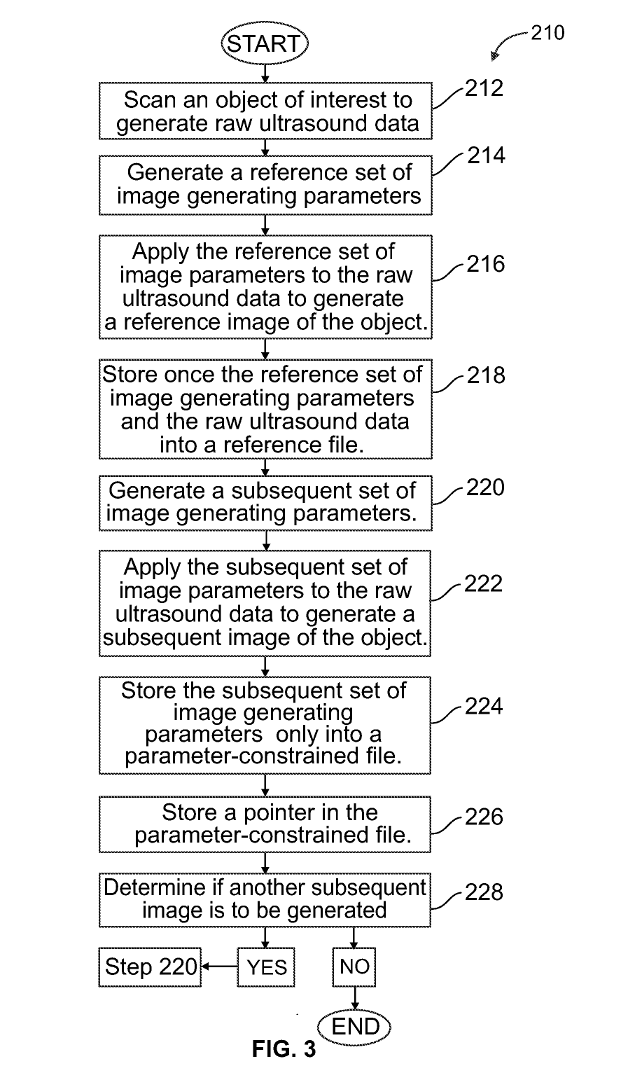

The user interface 124 controls the module 126. The module 126 accesses the memory 190 to obtain the raw 3D ultrasound data. The module 126 also operates to reduce the overall memory storage requirements of the ultrasound system 100. The module 126 implements a method 210 for reducing the overall memory storage requirements of the ultrasound system 100 as shown in FIG. 3. It should be noted that although the method 210 is described in connection with an ultrasound imaging system having particular characteristics, the various embodiments are not limited to the ultrasound imaging system described herein or to any particular imaging characteristics. The results of the method 210 may be stored in the storage requirements reducing module 126 or may be stored in a separate memory device such as memory device 114, 117, and/or memory device 190.

As shown in FIG. 3, the method 210 includes scanning an object to obtain raw 3D ultrasound data at 212. For example, in some embodiments, the raw 3D ultrasound data includes ultrasound information (e.g., image voxels) of an object, such as a heart. The 3D ultrasound data acquired during the scanning procedure is referred to herein as raw 3D ultrasound data. The raw ultrasound data represents ultrasound data acquired from the ultrasound probe 104 prior to any image processing techniques being performed on the reception data. The raw 3D ultrasound data may be data stored in a memory device. Optionally, the raw ultrasound data may be data currently being acquired during the imaging procedure. Additionally, the raw 3D data in various embodiments may represent a plurality of 2D or 3D datasets acquired over time. For example, in a cardiac application, the datasets may correspond to raw 3D ultrasound data of an imaged heart over one or more heart cycles that form a raw 4D ultrasound dataset.

At 214, the system 100 generates a set image generating parameters. At 216, the image generating parameters are applied to the raw ultrasound data to generate an image of the object being scanned. In use, the operator enters image generating parameters to manipulate the raw ultrasound data and form a desired image of the object. The set of image generating parameters may include for example, slice depth, gain, color mode, view angle, view direction, zoom factor, crop position, cut plane, etc. In the exemplary embodiment, the set of image generating parameters includes any parameters or commands, either automatically generated by the system or manually entered by the operator, that are used by the processor 116 to transform the raw ultrasound data into the image that is desired to be displayed by the operator. In the exemplary embodiment, the image generating parameters are each assigned a numeric value to enable the image to be recreated on demand by the operator.

At 218, once the operator has completed the manipulation of the raw image data set and produced an initial or first image which the operator desires to save, referred to herein as the reference image, the parameters utilized by the operator to form the reference image are stored as the set of image generating parameters for that particular image. The set of image generating parameters used to create the reference image are referred to herein as the reference set of image generating parameters. The reference set of image generating parameter are stored in the reference data file 250. The raw ultrasound data is also stored as a dataset in the reference data file 250 shown in FIG. 2. In one embodiment, the reference image is a single image of the object. In the exemplary embodiment, the reference image is a 2D projection movie or a cine loop of the object that corresponds to the raw 4D ultrasound data.

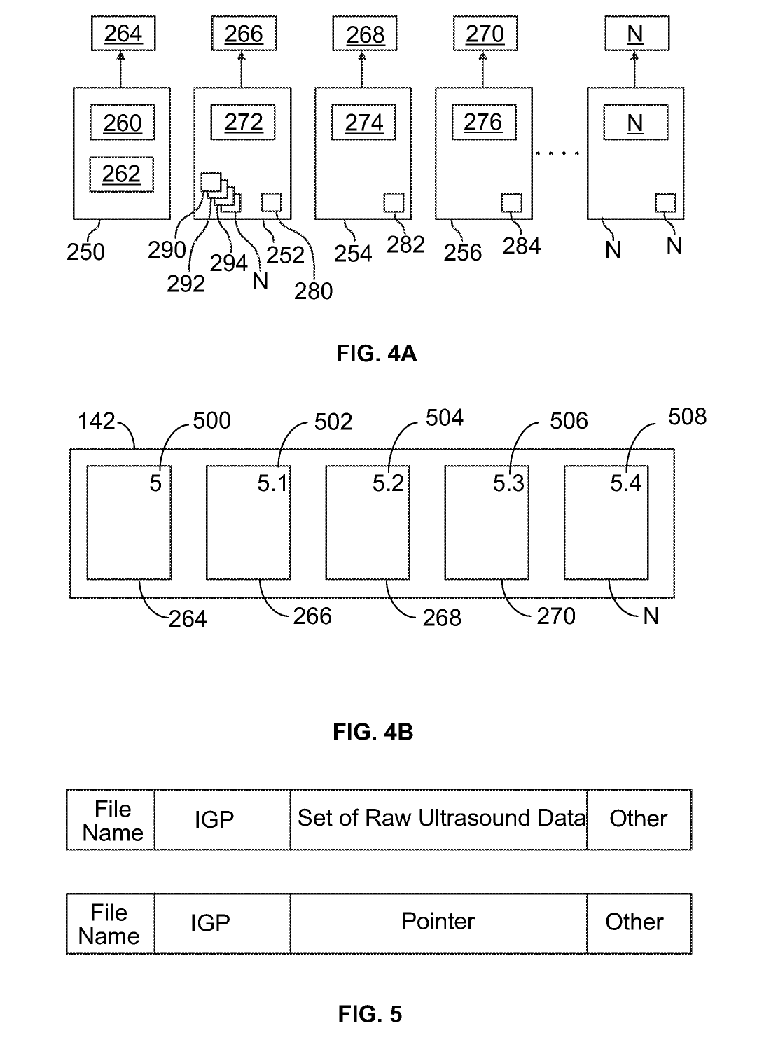

FIG. 4A illustrates a block schematic illustration of the exemplary reference data file 250 and a plurality of additional or subsequent image files 252 . . . N that may be generated using the method shown in FIG. 3. As used herein, a file represents a block of information which is utilized by the module 126 and/or the processor 116 to implement the methods described herein. A file may have any size and may be formatted to operate with the imaging system described herein. A file may include one or a plurality of datasets described herein and/or additional information. The additional information may include pointers, indicia, and/or other ultrasound information that may be applied to the raw ultrasound data to create an image.

FIG. 4B is a block diagram of an exemplary reference image and a set of subsequent images displayed on the user interface 142 in accordance with various embodiments of the invention. As shown in FIG. 4B, the user interface 142 is configured to display the reference image 264 and the subsequent images 266 . . . N that are generated based on the reference image 264. In the exemplary embodiment, the reference image 264 is assigned a first identifier 500 that indicates to an operator that the image 264 is the reference image. Additionally, each subsequent image is assigned a respective identifier to indicate to an operator that the subsequent images are generated using the reference image. For example, in this exemplary embodiment, the reference image 264 is assigned an indicator of “5”. The subsequent images are each assigned a second different indicator, e.g. 5.1, 5.2, 5.3, 5.4 etc. The first and second indicators enable the operator to determine which of the displayed images is the reference image and which of the displayed images form the subset of images that are generated based on the reference image.

FIG. 5 is a block schematic illustration of the exemplary reference file 250 and an exemplary parameter-constrained file 252. In the exemplary embodiment, the reference data file 250 includes the file name. The file name uniquely identifies the file stored in the ultrasound system 100. The file name may the protocol (or scheme), e.g. http, ftp, file etc.; the host (or network-ID), the host name, the host IP address, the host domain name, or the host LAN network name. The file name may also include the device or node, the directory or path, the type of file format or extension, or the file version. The reference file 250 also includes a set 260 of raw ultrasound data, a reference set 262 of image generating parameters, and other information utilized by the system 100 to process the file. The set 260 of raw ultrasound data and the reference set 262 of image generating parameters are used to generate a first or reference image 264 of the object. Optionally, the set 260 of raw ultrasound data and the reference set 262 of image generating parameters are used to generate a cine loop 265 of ultrasound images. The size of the reference data file 250, in the exemplary embodiment, is relatively large due to the inclusion of the set 260 of raw ultrasound data. The set 260 of raw ultrasound data represents dense volumetric 4D data that is acquired during the scanning procedure. The volume represents the IQ data pairs of the echo signals received scanning the object. The subsequent file 252 includes the file name, a set of image generating parameters, and other information utilized by the system 100 to process the file 252. The subsequent file 252 also includes a reference file pointer that links the set of imaging generating parameters stored in the file 252 with the set 260 of raw ultrasound data stored in the reference file 250.

Referring again to FIG. 3, at 220 a second set of image generating parameters are generated. At 222, the second set of image generating parameters is applied to the set 260 of raw ultrasound data that is stored in the reference data file 250. For example, as shown in FIG. 4A, the module 126 applies the second set 272 of image generating parameters to the set 260 of raw ultrasound data to generate a second image 266 of the object. In one embodiment, the operator enters the second set 272 of image generating parameters to manipulate the set 260 of raw ultrasound data and thus form the desired second image 266 of the object. Optionally, the operator enters the second set 272 of image generating parameters by manipulating the reference image(s) 264 or 265. The reference image may be a single image representing a 4D volume or a cine loop including multiple images. The second image 266 may be a portion of the first image manipulated to forma an image having a first zoom factor and a first view angle. In the exemplary embodiment, the set 260 of raw ultrasound data or the reference image 264 may be used to generate a plurality of subsequent images 266, 268, 270 . . . N. To generate the subsequent images 266 . . . N, the module 126 accesses the set 260 of raw ultrasound data that is stored in the reference data file 250. The second set of image generating parameters 272 are applied to the set 260 of raw ultrasound data to generate the second image 266. The second image may have a second zoom factor and a second view angle. A third set of image generating parameters 274 are applied to the set 260 of raw ultrasound data to generate the a third image 268. The third image may have a third zoom factor and a third view angle. A fourth set of image generating parameters 276 are applied to the set 260 of raw ultrasound data to generate the a fourth subsequent image 270. Any further subsequent images are generated as discussed above with respect to images 266-270.

The sets of image generating parameters 272 . . . N may include any parameters or commands, either automatically generated by the system or manually entered by the operator. The sets of image generating parameters are used by the module 126 to transform the raw ultrasound data into the image that is desired to be displayed by the operator. For example, the set 272 of image generating parameters may be utilized to generate the first image 266 depicting a slice having a first zoom factor and a first view angle. The second set 274 of image generating parameters may manipulate the set 260 of raw ultrasound data to generate the second subsequent image 268 depicting a different slice having a different zoom factor and a different view angle from the first image 266.

Referring again to FIG. 3, at 224 the subsequent set of image generating parameters is stored into a subsequent image file. For example, as shown in FIG. 4A, the set 272 of image generating parameters that are used to generate the image 266 are stored in the image file 252. The set 274 of image generating parameters that are used to generate the image 268 are stored in the image file 254. The set 276 of image generating parameters that are used to generate the image 270 are stored in the file 256, etc.

In the exemplary embodiment, the sets 272 . . . N of image generating parameters are stored in each respective image file 252 . . . N. The reference data file 250 includes both the set 260 of raw ultrasound data and the set 262 of image generating parameters that are used to generate the reference image 264. To generate the subsequent images 266 . . . N, the module 126 accesses the set 260 of raw ultrasound data stored in the reference data file 250 to enable the operator to generate the subsequent images. To re-create any of the above described subsequent images 266 . . . N, the module 126 accesses the set 260 of raw ultrasound data stored in the reference data file 250 to enable the operator to generate or re-create the subsequent images. In the exemplary embodiment to reduce the file sizes of the subsequent images that are each produced using the same raw ultrasound data as the reference image, the set 260 of raw ultrasound data is not stored in the subsequent files.

Referring again to FIG. 3, the method further includes at 226 storing a reference file pointer in the subsequent image file. The pointer enables the module 126 to determine the location of the set 260 of raw ultrasound data that was used to generate a specific subsequent image. For example, as shown in FIG. 4A, in the exemplary embodiment, the set 260 of raw ultrasound data is used to generate the subsequent image 266. To recreate the subsequent image 266, the module 126 determines the location of the set 260 of raw ultrasound data. In this example, the set 260 of raw ultrasound data is stored in the reference data file 250. The module 126 utilizes a pointer 280 stored in the file 252 to determine the location of the set 260 of raw ultrasound data. In this example, the pointer 280 directs the module 126 to access the set 260 of raw ultrasound data stored in the reference data file 250. The module 126 uses the set 260 of raw ultrasound data to re-create the image 262 based on the set 272 of image generating parameters. As shown in FIG. 4A, each subsequent image file 266 . . . N includes an ultrasound link or pointer 280 . . . N that identifies that location of the raw ultrasound data that was used to generate the respective image 266 . . . N.

A pointer as used herein “points to” or “links” the set 260 of raw ultrasound data stored in the reference data file 250 to the set of image generating parameters stored in each respective subsequent file 252 . . . N. The pointers each refer to the location in memory, file location, network location etc) where the reference file with raw ultrasound dataset is stored. The pointers therefore enable the module 126 to access the set 260 of raw ultrasound dataset when the operator desires to create subsequent images.

Referring again to FIG. 3, at 228 the module 126 determines if another subsequent image is to be generated using the set 260 of raw ultrasound data. If the operator selects to generate an additional subsequent image, e.g. image 268, the subsequent image 268 is generated in the same manner as discussed above with image 266. Optionally, the program is terminated.

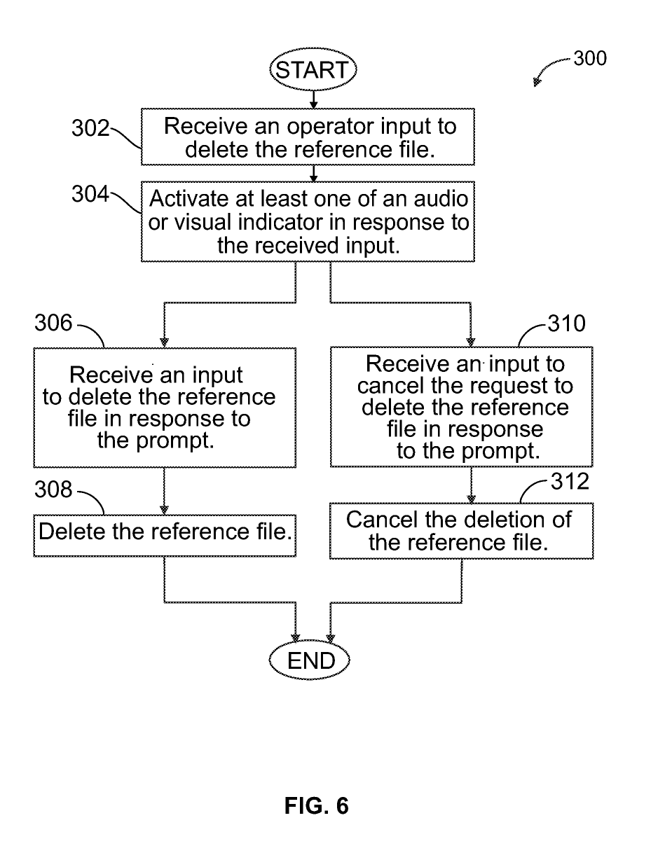

FIG. 6 is a flowchart of an exemplary method 300 of deleting a reference data file that includes raw ultrasound data. For example, as discussed above, the reference data file 250 includes the set 260 of raw ultrasound data that is used to generate the subsequent images, 266, 268, 270, etc. Moreover, each subsequent image file 252, 254, 256 does not include a copy of the set 260 of raw ultrasound data to reduce the file size and therefore reduce the storage requirements for the ultrasound system. Therefore, deleting a reference data file 250 that includes the set 260 of raw ultrasound data also results in eliminating the operator's ability to generate additional subsequent images using the set 260 of raw ultrasound data. Therefore, in the exemplary embodiment the method 300 includes at 302 receiving an operator input to delete a reference data file, e.g. reference data file 250. At 304 at least one of an audio or visual indicator is activated in response to the received request. The audio or visual indicator provides a warning to an operator that the reference data file is selected to be deleted. At 306 the operator may input a request to proceed with the deletion of the reference data file. At 308, the module 126 deletes the reference data file. Optionally, at 310 the operator may input a request to cancel the deletion of the reference data file. At 312, the module 126 cancels the request to delete the reference data file.

In the exemplary embodiment, each of the subsequent image files, e.g. 252, 254, 256, etc. may include additional bitmaps that represent the subsequent images generated and stored in each respective file. As discussed above, the subsequent image 266 is generated using the set 260 of raw ultrasound data. However, if the reference data file 250 is deleted, each of the subsequent image files may include at least one or a plurality of bitmaps that represent the subsequent image generated. For example, the subsequent image file 252 may include at least one bitmaps 290 that represents at least a portion of the image 266. Optionally, the subsequent image file 252 may include a plurality of images 290, 292, 294, 296, etc. that represent the image 266. Optionally, the images 290 . . . 296 may be in the form of jpegs etc. In each case, the type of images 290 . . . 296 is selected to maintain a reduced file size of the subsequent image files. In another exemplary embodiment, to reduce the size of the reference data file 250, the set 260 of raw ultrasound data may be compressed to further increase storage capacity of the imaging system.

In the exemplary embodiment described herein, reference data file and the subsequent image files may be encoded according to the Digital Imaging and Communications in Medicine (DICOM) standard and communicated between a HIS/RIS server and the imaging system described herein through a communication link, using DICOM protocol or other similar communication protocol.

Described herein is a system and method for significantly reducing the storage space and network data transfer capacity required for ultrasound images when such images are restored several times. The system and method are particularly applicable to volume ultrasound data which requires large quantities of storage space and are typically restored after user manipulations. For example, ultrasound volume data contains both the raw ultrasound data itself (from the image acquisition) and other information related to view positions, crop planes, volume rendering parameters etc. When the user adjusts this information to look for specific attributes in the image or to make measurements, he or she can restore this image to save these new settings. Several such images are often created based on one data acquisition.

To reduce the demands on the system storage devices and echo lab network, such additional restored data only contains the information used to generate the image not the raw ultrasound data. The raw data is stored only once and the subsequent stored images include pointers to the original or reference data file that includes the raw ultrasound data. The only information stored in these image files is the information used to generate the specific image. This is handled completely transparent to the user and also handled within a Dicom database environment. During operation, the system is configured to look for the raw data in another file (which might already be available in a file cache), then apply its own information to the raw data to generate the requested image. The system and methods described herein therefore reduce the storage space required to store ultrasound images and also reduce network transfer times. The system and methods described herein may be used with the exemplary imaging system shown in FIGS. 1 and 2. Optionally, other imaging systems may be utilized.

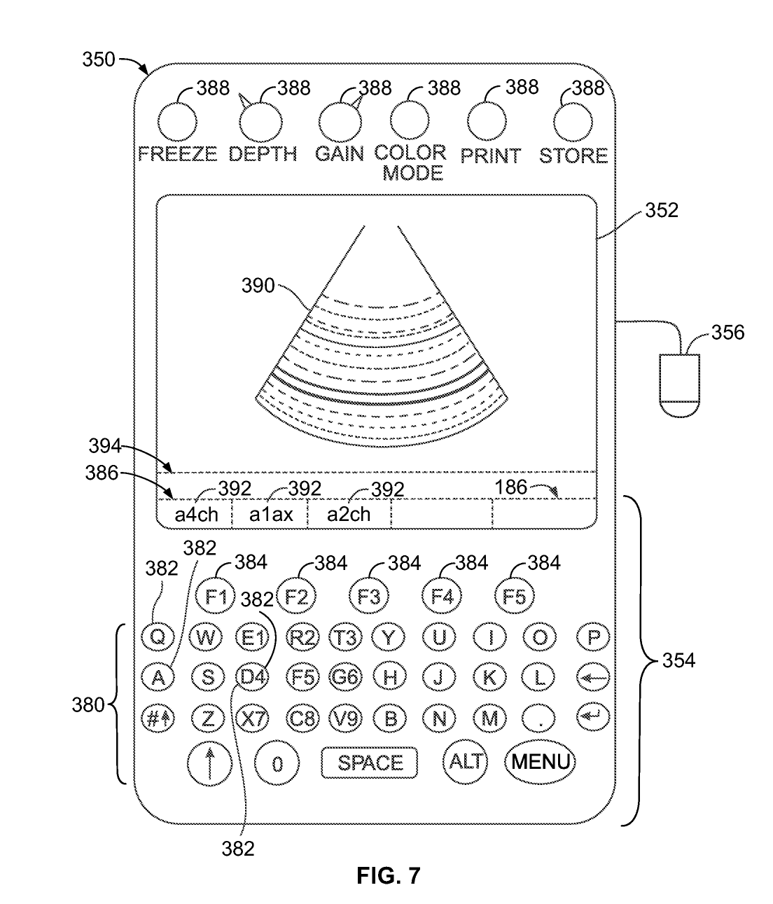

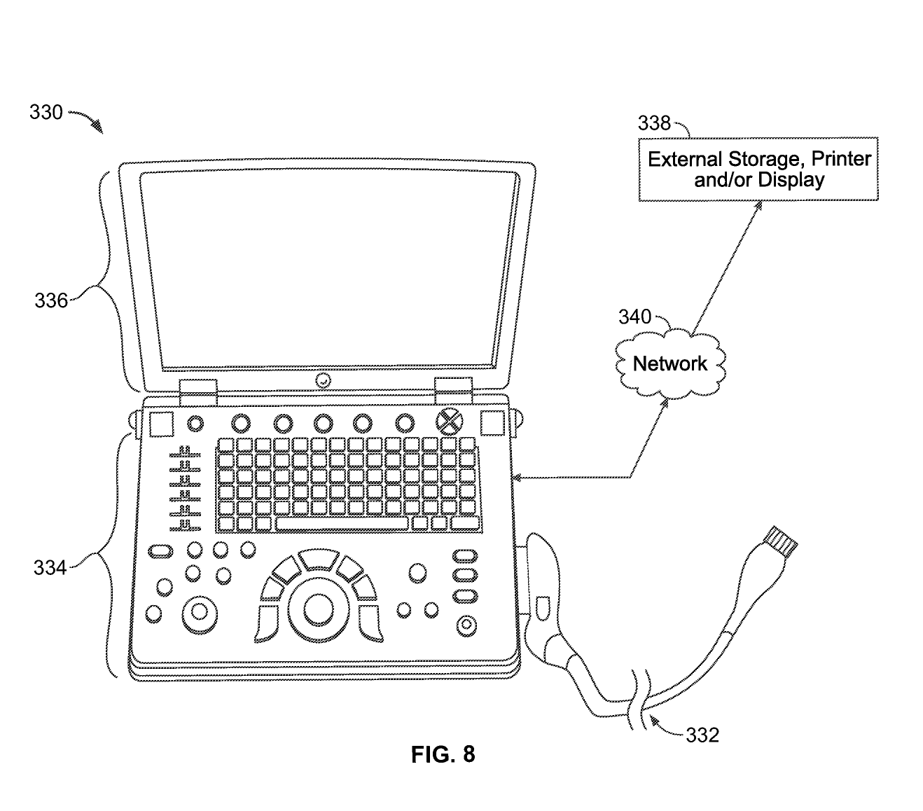

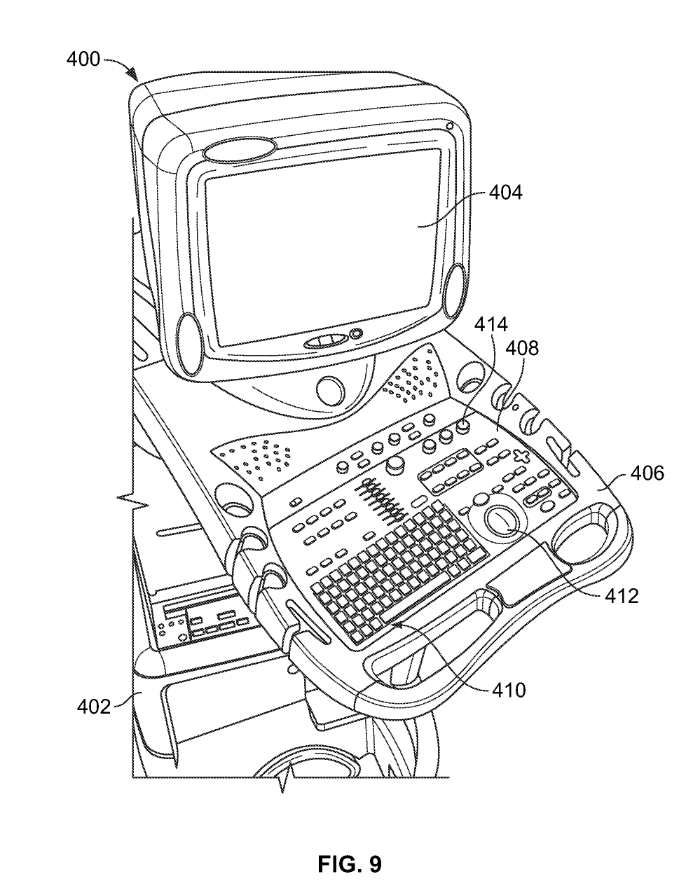

More specifically, the ultrasound system 100 of FIG. 1 may be embodied in a small-sized system, such as laptop computer or pocket sized system as well as in a larger console-type system. FIGS. 7 and 8 illustrate small-sized systems, while FIG. 9 illustrates a larger system.

FIG. 7 illustrates a 3D-capable miniaturized ultrasound system 330 having a probe 332 that may be configured to acquire 3D ultrasonic data or multi-plane ultrasonic data. For example, the probe 332 may have a 2D array of elements 104 as discussed previously with respect to the probe 106 of FIG. 1. A user interface 334 (that may also include an integrated display 336) is provided to receive commands from an operator. As used herein, “miniaturized” means that the ultrasound system 330 is a handheld or hand-carried device or is configured to be carried in a person's hand, pocket, briefcase-sized case, or backpack. For example, the ultrasound system 330 may be a hand-carried device having a size of a typical laptop computer. The ultrasound system 330 is easily portable by the operator. The integrated display 336 (e.g., an internal display) is configured to display, for example, one or more medical images.

The ultrasonic data may be sent to an external device 338 via a wired or wireless network 340 (or direct connection, for example, via a serial or parallel cable or USB port). In some embodiments, the external device 338 may be a computer or a workstation having a display. Alternatively, the external device 338 may be a separate external display or a printer capable of receiving image data from the hand carried ultrasound system 330 and of displaying or printing images that may have greater resolution than the integrated display 336.

FIG. 8 illustrates a hand carried or pocket-sized ultrasound imaging system 350 wherein the display 352 and user interface 354 form a single unit. By way of example, the pocket-sized ultrasound imaging system 350 may be a pocket-sized or hand-sized ultrasound system approximately 2 inches wide, approximately 4 inches in length, and approximately 0.5 inches in depth and weighs less than 3 ounces. The pocket-sized ultrasound imaging system 350 generally includes the display 352, user interface 354, which may or may not include a keyboard-type interface and an input/output (I/O) port for connection to a scanning device, for example, an ultrasound probe 356. The display 352 may be, for example, a 320×320 pixel color LCD display (on which a medical image may be displayed). A typewriter-like keyboard 380 of buttons 382 may optionally be included in the user interface 354.

Multi-function controls 384 may each be assigned functions in accordance with the mode of system operation (e.g., displaying different views). Therefore, each of the multi-function controls 384 may be configured to provide a plurality of different actions. Label display areas 386 associated with the multi-function controls 384 may be included as necessary on the display 352. The system 350 may also have additional keys and/or controls 388 for special purpose functions, which may include, but are not limited to “freeze,” “depth control,” “gain control,” “color-mode,” “print,” and “store.”

One or more of the label display areas 386 may include labels 392 to indicate the view being displayed or allow a user to select a different view of the imaged object to display. For example, the labels 392 may indicate an apical 4-chamber view (a4ch), an apical long axis view (alax) or an apical 2-chamber view (a2ch). The selection of different views also may be provided through the associated multi-function control 384. For example, the 4ch view may be selected using the multi-function control F5. The display 352 may also have a textual display area 394 for displaying information relating to the displayed image view (e.g., a label associated with the displayed image).

It should be noted that the various embodiments may be implemented in connection with miniaturized or small-sized ultrasound systems having different dimensions, weights, and power consumption. For example, the pocket-sized ultrasound imaging system 350 and the miniaturized ultrasound system 330 may provide the same scanning and processing functionality as the ultrasound system 100 (shown in FIG. 1).

FIG. 9 illustrates a portable ultrasound imaging system 400 provided on a movable base 402. The portable ultrasound imaging system 400 may also be referred to as a cart-based system. A display 404 and user interface 406 are provided and it should be understood that the display 404 may be separate or separable from the user interface 406. The user interface 406 may optionally be a touch screen, allowing the operator to select options by touching displayed graphics, icons, and the like.

The user interface 406 also includes control buttons 408 that may be used to control the portable ultrasound imaging system 400 as desired or needed, and/or as typically provided. The user interface 406 provides multiple interface options that the user may physically manipulate to interact with ultrasound data and other data that may be displayed, as well as to input information and set and change scanning parameters and viewing angles, etc. For example, a keyboard 410, trackball 412 and/or multi-function controls 414 may be provided.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for storing medical imaging information, the method comprising:
storing raw medical data of a scanned object in a reference data file;
storing a set of image generating parameters into a parameter-constrained file that is separate from the reference data file;
linking the set of image generating parameters stored in the parameter-constrained file to the reference data file; and
generating an image by applying the set of image generating parameters to the reference data file.

2. A method in accordance with claim 1 further comprising storing an image generating parameter pointer in the parameter-constrained file, the image generating parameter pointer identifying a storage location of the raw medical data in the reference data file.

3. A method in accordance with claim 1 further comprising storing at least one bitmap in the parameter-constrained file, the at least one bitmap being representative of at least a portion of the image.

4. A method in accordance with claim 1 further comprising activating at least one of an audio or visual indicator when a command is received to delete the reference data file.

5. A method in accordance with claim 1 wherein the raw medical data includes a plurality of frames of 3D ultrasound data together forming a four-dimensional (4D) ultrasound dataset, said method further comprising storing once the 4D ultrasound dataset into the reference data file.

6. A method in accordance with claim 1 further comprising compressing the raw medical data to reduce the size of the reference data file.

7. A method in accordance with claim 1 further comprising storing a reference set of image generating parameters into the reference data file, the reference set of imaging generating parameters being used to generate a reference image of the object.

8. A method in accordance with claim 1 further comprising:
storing once, the raw medical data of a scanned object in the reference data file; and
applying the set of image generating parameters stored in the parameter-constrained file to the raw ultrasound data to generate an ultrasound image of the object.

9. A memory storage requirements reducing module programmed to:
store raw medical data of a scanned object in a reference data file;
store a set of image generating parameters into a parameter-constrained file that is separate from the reference data file;
linking the set of image generating parameters stored in the parameter-constrained file to the reference data file; and
generate an image by applying the set of image generating parameters to the reference data file.

10. The module of claim 9 further programmed to store an image generating parameter pointer in the parameter-constrained file, the image generating parameter pointer identifying the raw medical data in the reference data file.

11. The module of claim 9 further programmed to store at least one bitmap in the parameter-constrained file, the at least one bitmap being representative of at least a portion of the image.

12. The module of claim 9 further programmed to activate at least one of an audio or visual indicator when a command is received to delete the reference data file.

13. The module of claim 9 further programmed to store raw medical data that includes a plurality of frames of 3D ultrasound data together forming a four-dimensional (4D) ultrasound dataset into the reference data file.

14. The module of claim 9 further programmed to compress the raw ultrasound data stored in the reference data file to reduce the size of the reference data file.

15. The module of claim 9 further programmed to store a reference set of image generating parameters into the reference data file, the reference set of imaging generating parameters being used to generate a reference image of the object.

16. An ultrasound imaging system comprising:
an ultrasound probe configured to acquire three-dimensional (3D) data of an object; and
a memory storage requirements reducing module receiving data from the ultrasound probe, the memory storage requirements reducing module programmed to
store raw ultrasound data of a scanned object in a reference data file;
store a set of image generating parameters into a parameter-constrained file that is separate from the reference data file;
link the set of image generating parameters stored in the parameter-constrained file to the reference data file; and
generate an image of the scanned object by applying the set of image generating parameters to the reference data file.

17. The ultrasound imaging system of claim 16 wherein the module is further programmed to store an image generating parameter pointer in the parameter-constrained file, the image generating pointer identifying a storage location of the raw medical data in the reference data file.

18. The ultrasound imaging system of claim 16 wherein the module is further programmed to store at least one bitmap in the parameter-constrained file, the at least one bitmap being representative of at least a portion of the image.

19. The ultrasound imaging system of claim 16 wherein the module is further programmed to activate at least one of an audio or visual indicator when a command is received to delete the reference data file.

20. The ultrasound imaging system of claim 16 wherein the module is further programmed to compress the raw ultrasound data stored in the reference data file to reduce the size of the reference data file.

21. The ultrasound imaging system of claim 16 further comprising a user interface configured to display a reference image of the scanned object and at least one additional image generated using the set of image generating parameters, the reference image having a first identifier, the additional image having a second identifier, the second identifier indicating that the additional image is a subset of the reference image.
